(19) United States
(12) Patent Application Publication
(10) Pub. No.: US 2009/0177916 A1
(43) Pub. Date: Jul. 9, 2009

(54) STORAGE SYSTEM, CONTROLLER OF STORAGE SYSTEM, CONTROL METHOD OF STORAGE SYSTEM

(75) Inventor: Hirotomo TOKORO, Kawasaki (JP)

Correspondence Address: Fujitsu Patent Center;C/O CPA Global, P.O. Box 52050, Minneapolis, MN, 55402, US

(73) Assignee: FUJITSU LIMITED, Kawasaki (JP)

(21) Appl. No.: 12/254,006

(22) Filed: Oct. 19, 2008

(30) Foreign Application Priority Data
Jan. 8, 2008 (JP) 2008-001444

(51) Int. Cl. G06F 11/14; G06F 11/30; G06F 12/16

(52) U.S. Cl. 714/6; 711/162; 714/E11.117; 714/E11.179; 711/E12.103

(57) ABSTRACT

A storage system includes: an interface that connects the storage system to a higher-level device; a first storage unit that stores data which is transferred from the higher-level device through the interface; a second storage unit onto which data stored in the first storage unit is copied; a management table that manages the progress of the copy operation; a monitoring section that monitors the operating state of the first storage unit; a determination section that determines, in the case where the monitoring section detects occurrence of a failure in the first storage unit, that the access destination in the first storage unit specified by the higher-level device is accessible or not; and a selection section that selects the access destination specified by the higher-level device based on the determination result of the determination section and progress managed by the management table.

### BACKGROUND OF THE INVENTION

1. Field of the Invention

The present invention relates to a storage system performing data copy between storages, a controller of the storage system, and a control method of the storage system.

2. Description of the Related Art

An OPC (One Point Copy), an EC (Equivalent Copy), and the like are provided in current storage products as a copy function (advanced copy function) for mirroring or backup of data on a storage.

The EC reflects, immediately after data on a copy source storage is updated, the updated data on a copy destination storage. In the case where a backup of data on a copy source storage is created on a copy destination storage, the EC temporarily releases an equivalent state between the copy source storage and copy destination storage so as to create a snapshot of the copy source storage on the copy destination storage. The OPC creates, immediately after receiving a snapshot creation instruction, a snapshot of a copy source storage at that time point on a copy destination storage. Here, a physical copy is created as a background process.

There are known the following techniques as a prior art relating to the present invention: a storage area network system in which an auxiliary disk system connected with a storage area network is substituted for a primary disk system if it has failed (refer to, e.g., Patent Document 1: International Publication 01/029647 pamphlet); a storage system in which if a failure is detected in input/output operation in a first storage volume, a recovery process wherein the path to second storage volume or a third storage volume from a host device is designated to automatically continue the input/output operation is started (refer to, e.g., Patent Document 2: Jpn. Pat. Appln. Laid-Open Publication No. 2006-99744); and a storage system capable of switching to a continued operation using backup data without delay upon a failure in a storage device (refer to, e.g., Patent Document 3: Jpn. Pat. Appln. Laid-Open Publication No. 2006-260141).

Conventionally, in the case where a multiple-disk failure has occurred in a RAID (Redundant Arrays of Inexpensive Disks) as a primary volume under the environment where the EC is used to operate a storage system by mirroring with the RAID used as a copy source, restoration and restart of operation are attained as follows.

(1) Administrator replaces a suspect disk serving as a copy source with a new disk and carries out restoration work using backup data (data on a copy destination disk).

(2) Administrator changes the copy source volume to copy destination volume depending on the setting from a host.

However, in this method, much time is taken from the start of the restoration work to restart of operation to adversely affect business operations, resulting in excessive loss.

Further, in the case where a multiple-disk failure has occurred during data backup from a copy source to copy destination (i.e., in a nonequivalent state), it is not possible to restore the latest state only with data of the copy source.

### SUMMARY OF THE INVENTION

The present invention has been made to solve the above problem and an object thereof is to provide a storage system performing data copy between storages, a controller of the storage system, and a control method of the storage system capable of improving reliability of the storage system in the case where a failure occurs in a copy source.

To solve the above problem, according to a first aspect of the present invention, there is provided a storage system comprising: an interface that connects the storage system to a higher-level device; a first storage unit that stores data which is transferred from the higher-level device through the interface; a second storage unit onto which data stored in the first storage unit is copied; a management table that manages the progress of the copy operation; a monitoring section that monitors the operating state of the first storage unit; a determination section that determines, in the case where the monitoring section detects occurrence of a failure in the first storage unit, that the access destination in the first storage unit specified by the higher-level device is accessible or not; and a selection section that selects the access destination specified by the higher-level device based on the determination result of the determination section and progress managed by the management table.

According to a second aspect of the present invention, there is provided a controller of a storage system having a first storage unit that stores data which is transferred from a higher-level device through an interface connected to the higher-level device and a second storage unit onto which data stored in the first storage unit is copied, comprising: a management table that manages the progress of the copy operation; a monitoring section that monitors the operating state of the first storage unit; a determination section that determines, in the case where the monitoring section detects occurrence of a failure in the first storage unit, that the access destination in the first storage unit specified by the higher-level device is accessible or not; and a selection section that selects the access destination specified by the higher-level device based on the determination result of the determination section and progress managed by the management table.

According to a third aspect of the present invention, there is provided a control method of a storage system having a first storage unit that stores data which is transferred from a higher-level device through an interface connected to the higher-level device and a second storage unit onto which data stored in the first storage unit is copied, comprising: a management step that manages the progress of the copy operation; a monitoring step that monitors the operating state of the first storage unit; a determination step that determines, in the case where the monitoring step detects occurrence of a failure in the first storage unit, that the access destination in the first storage unit specified by the higher-level device is accessible or not; and a selection step that selects the access destination specified by the higher-level device based on the determination result of the determination step and progress managed by the management step.

According to the storage system, controller of the storage system, and control method of the storage system of the present invention, it is possible to improve reliability of a storage in which mirroring is conducted in the case where a failure has occurred in the copy source.

### BRIEF DESCRIPTION OF THE DRAWINGS

FIG. 1 is a block diagram showing an example of a configuration of a storage system according to an embodiment of the present invention;

FIG. 2 is a conceptual view showing the outline of operation performed in response to a Write request made after occurrence of a multiple-disk failure in a copy source of the storage system according to the present embodiment;

FIG. 3 is a conceptual view showing the outline of operation performed in response to a Read request made after occurrence of a multiple-disk failure in a copy source of the storage system according to the present embodiment;

FIG. 4 is a conceptual view showing an example of operation performed in response to a Write request issued after occurrence of a multiple-disk failure in the copy source in the synchronous mode in the equivalent state;

FIG. 5 is a conceptual view showing an example of operation performed in response to a Read request issued after occurrence of a multiple-disk failure in the copy source in the synchronous mode in the equivalent state;

FIG. 6 is a conceptual view showing an example of operation performed in response to a Write request issued after occurrence of a multiple-disk failure in the copy source in the asynchronous mode in the equivalent state;

FIG. 7 is a conceptual view showing an example of access control per unit area performed in response to a Write request issued after occurrence of a multiple-disk failure in the copy source in the asynchronous mode in the equivalent state;

FIG. 8 is a table showing an example of a bit map control table in the asynchronous mode in the equivalent state;

FIG. 9 is a conceptual view showing an example of operation performed in response to a Write request issued after occurrence of a multiple-disk failure in the copy source in the nonequivalent state;

FIG. 10 is a conceptual view showing an example of operation performed in response to a Read request issued after occurrence of a multiple-disk failure in the copy source in the nonequivalent state;

FIG. 11 is a conceptual view showing an example of access control per unit area performed in response to a Write request issued after occurrence of a multiple-disk failure in the copy source in the nonequivalent state;

FIG. 12 is a table showing an example of the bit map control table according to the present embodiment;

FIG. 13 is a conceptual view showing an example of operation performed in response to a Write/Read request during restoration of the copy source;

FIG. 14 is a flowchart showing an example of operation of the storage system according to the present embodiment performed in response to a Write request; and

FIG. 15 is a flowchart showing an example of operation of the storage system according to the present embodiment performed in response to a Read request.

### DETAILED DESCRIPTION OF THE PREFERRED EMBODIMENTS

An embodiment of the present invention will be described with reference to the accompanying drawings.

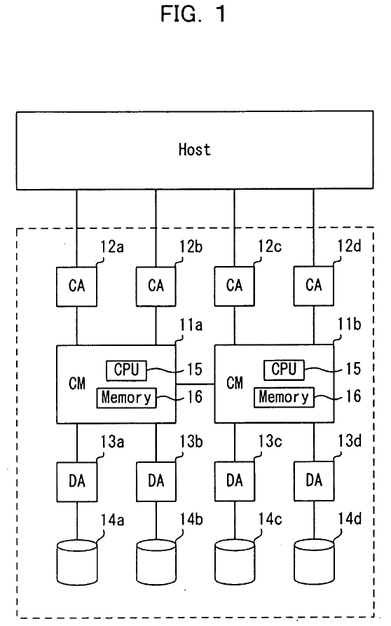

FIG. 1 is a block diagram showing an example of a configuration of a storage system according to an embodiment of the present invention. The storage system shown in FIG. 1 includes CMs (Centralized modules) 11a and 11b, four CAs (channel Adaptors) 12a, 12b, 12c, and 12d, four DAs (Device Adaptors) 13a, 13b, 13c, and 13d, and disks 14a, 14b, 14c, and 14d. The CMs 11a and 11b, each having a CPU 15 and a memory 16, execute firmware to perform configuration control, copy control, and cache control. In the configuration control, the CMs 11a and 11b perform recognition and notification in the case where a change (disk failure, etc.) occurs in a state of the storage system. In the copy control, the CMs 11a and 11b makes a transfer instruction of control information or data of a copy source and a copy destination. In the cache control, the CMs 11a and 11b perform control of a cache memory area in a memory and storage control of user data or control information.

The CAs 12a, 12b, 12c, and 12d perform communication with a host (higher-level device) through an FC (Fibre Channel), an iSCSI (Internet Small Computer System Interface), and the like. The DAs 13a, 13b, 13c, and 13d perform communication with the disks 14a, 14b, 14c, and 14d, respectively, through the FC, an SATA (Serial ATA), an SAS (Serial Attached SCSI), and the like. The disks 14a, 14b, 14c, and 14d are HDDs (Hard Disk Drive).

In the storage system according to the present embodiment, the disks 14a and 14b constitute a RAID, and disks 14c and 14d constitute another RAID. Further, in the present embodiment, a group constituted by the CM 11a, CAs 12a and 12b, DAs 13a and 13b, and disks 14a and 14b is set as a copy source and a group constituted by the CM 11b, CAs 12c and 12d, DAs 13c and 13d, and disks 14c and 14d is set as a copy destination.

The outline of EC operation will next be described. An EC state representing a state where the EC operation is performed includes a non-equivalent state and an equivalent state. Immediately after the EC operation is started with an EC copy source and an EC copy destination designated, the EC state becomes the nonequivalent state. In the nonequivalent state, the CMs 11a and 11b perform backup operation from the copy source to the copy destination until equivalence is established between the copy source and copy destination. After completion of the backup operation, the EC state becomes the equivalent state. In the equivalent state, the CMs 11a and 11b reflect a change in the copy source on the copy destination to maintain the equivalence between the copy source and copy destination. The equivalent state is ended when an EC stop instruction is issued from the host. Although the equivalence between the copy source and copy destination is not maintained after the EC operation is stopped, the copy source and copy destination are isolated from each other to allow them to be accessed as independent storages.

An operation mode representing the EC operation includes a synchronous mode and an asynchronous mode. When the CM 11a receives a data update request from the host in the synchronous mode in the equivalent state, the operation procedure is as follows: (1) the CM 11a updates the copy source; (2) the CM 11a issues to the CM 11b a data update request of the same content as that the copy source has received from the host; (3) the CM 11b updates the copy destination; (4) the CM 11b reports completion of the update to the CM 11a; and (5) the CM 11a reports completion of the update to the host. On the other hand, when the CM 11a receives a data update request from the host in the asynchronous mode in the equivalent state, the operation procedure is as follows: (1) the CM 11a updates the copy source; (2) the CM 11a reports completion of the update to the host; (3) the CM 11a issues to the CM 11b a data update request of the same content as that the copy source has received from the host; (4) the CM 11b updates the copy destination; and (5) the CM 11b reports completion of the update to the CM 11a.

That is, the update processing is completed both in the copy source and copy destination at the time of point when the host completes Write operation in the synchronous mode in the equivalent state; while, in the asynchronous mode in the equivalent state, the update processing is completed only in the copy source at the time of point when the host completes Write operation.

Copy operation from the copy source to copy destination is performed per unit area of a predetermined size (e.g., 8 k bytes). The CM 11a manages each unit area using a bit map control table (management table) on a memory. Each bit in the bit map control table corresponds to the logical address of each unit area and indicates whether the corresponding unit area is “data-transferred” area or “data-untransferred” area (whether data in the corresponding unit area has been transferred or not). The CM 11a can manage the progress of the copy operation by using the bit map control table. Similarly, at the time when the copy source is restored, the CM 11a manages whether data in each unit area has been transferred from the copy source to copy destination by using the bit map control table on a memory.

The outline of operation of the storage system according to the present embodiment will be described.

In the present embodiment, operation of the storage system performed in the case where a multiple-disk failure has occurred in the copy source RAID, i.e., in the case where there has occurred the possibility of data loss in the copy source, will be described.

If partial data loss occurs in the logical volume constituted by a plurality of physical volume, the storage system according to the present embodiment switches the logical volume from the copy source to the copy destination. Further, the storage system uses accessible data in the logical volume in which multiple failures have occurred to perform data restoration. In other words, the storage system according to the present embodiment saves effective data as much as possible by determining availability of access to the entire logical volume and data to be accessed so as to improve reliability of copy operation.

In the case where disks are multiply isolated from one another due to some failure in the copy source to induce a RAID closure state, the CM 11a uses mirroring data of the copy destination to reply to the host, behaving as if it were the copy source. This allows continuation of business operation while keeping the current operation condition. In the case where an access such as a Read/Write request is made to the copy source, the CM 11a guarantees data by performing the following operation.

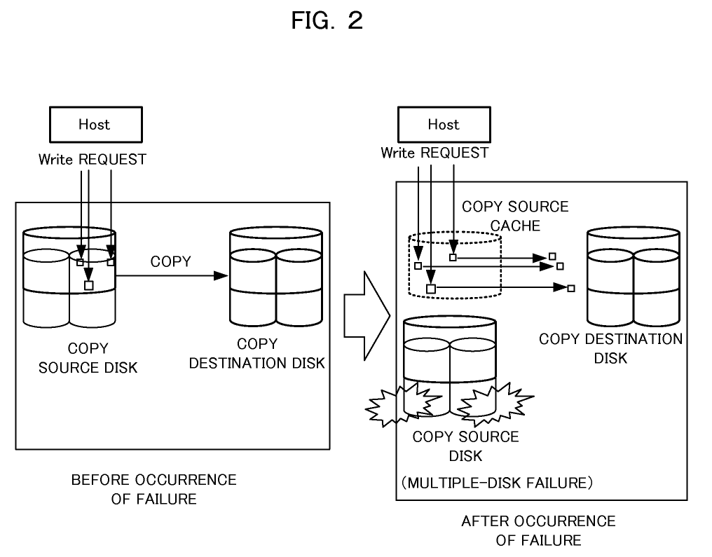

FIG. 2 is a conceptual view showing the outline of operation performed in response to a Write request made after occurrence of the a multiple-disk failure in the copy source of the storage system according to the present embodiment. The left side of FIG. 2 shows the operation before the occurrence of a multiple-disk failure in the copy source, and the right side thereof shows the operation after the occurrence of a multiple-disk failure in the copy source. In the case where data before update exist in the copy destination at the time when a Write request is issued from the host to the copy source after the occurrence of a multiple-disk failure in the copy source, the CM 11a writes updated data to the copy destination.

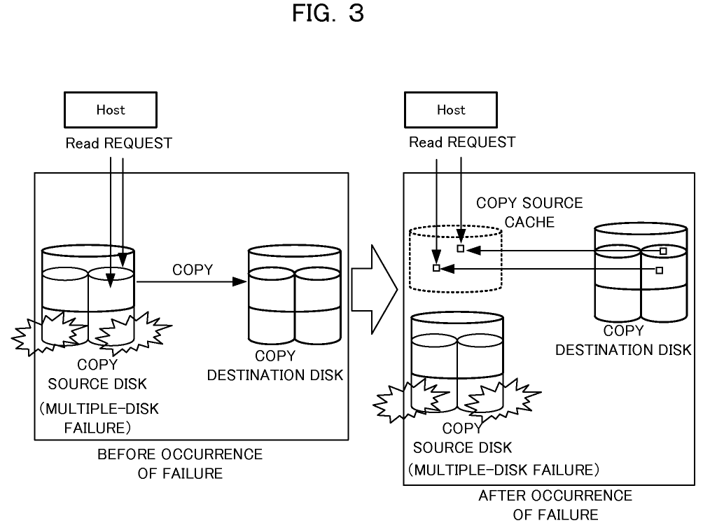

FIG. 3 is a conceptual view showing the outline of operation performed in response to a Read request made after occurrence of a multiple-disk failure in the copy source of the storage system according to the present embodiment. The left side of FIG. 3 shows the operation before the occurrence of a multiple-disk failure in the copy source, and the right side thereof shows the operation after the occurrence of a multiple-disk failure in the copy source. In the case where data exists in the copy destination at the time when a Read request is issued from the host to the copy source after the occurrence of a multiple-disk failure in the copy source, the CM 11a reads the data of the copy destination and transfers it to the host.

In the case where the RAID closure state occurs in the copy source volume at the non-equivalent state, the CM 11a tries to perform Read operation of data from the failed copy source disk and, if it can read the data, transfers the data to the host and copies the data to the copy destination.

Further, in the case of the equivalent state, the CM 11a uses the data of the copy destination so as to allow access operation to thereby guarantee data. In the case where the area accessed in the nonequivalent state is the “data-untransferred” area, the CM 11a reads in data from the copy source disk immediately and transfers it to the copy destination disk to restore data of the copy source, whereby the restoration of the copy source data and guarantee of the data are achieved.

Next, operation of the storage system at the time when a multiple-disk failure occurs in the copy source in the synchronous mode in the equivalent state will be described.

When a multiple-disk failure has occurred in the copy source RAID in the synchronous mode in the equivalent state, the CM 11a recognizes that the copy source is in a disabled state and, when receiving a Write request from the host, the CM 11a performs data write not to the copy source disk but only to the copy destination. Further, when receiving a Read request from the host, the CM 11a reads data from the copy destination disk to enable continuous operation.

That is, the copy destination disk acts like the copy source disk, so that it is possible for a higher-layer application (e.g., application on a host machine) to ongoingly perform data access operation without being aware of the failures.

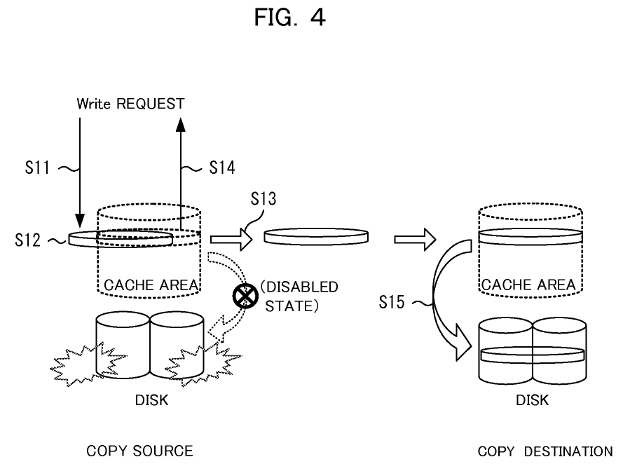

Operation of the storage system in the case where a Write request is issued from the host to copy source after occurrence of a multiple-disk failure in the copy source will be described. FIG. 4 is a conceptual view showing an example of operation performed in response to a Write request issued after occurrence of a multiple-disk failure in the copy source in the synchronous mode in the equivalent state.

(S11) The CM 11a receives the Write request which is issued from the host to copy source.

(S12) The CM 11a allocates a cache area corresponding to the access range (unit area including the Write target) to a memory (storage area) in the CM 11a and writes the Write request data in the cache area (staging). The cache area is allocated per unit area.

(S13) When recognizing that the current operation mode is the synchronous mode in the equivalent state, the CM 11a allows the CM 11b to allocate a cache area for data transfer to a memory in the CM 11b and transfers the cache data (temporarily stored data) of the copy source to the cache area of the copy destination. Further, when recognizing that the copy source disk is in a disabled state by checking the condition of the copy source disk, the CM 11a does not perform data write operation to the copy source disk.

(S14) When recognizing that data in the copy source cache area has been written in the copy destination cache area, the CM 11a notifies, as a reply, the host of completion of the Write request.

(S15) The CM 11b writes the data written in the copy destination cache area to the copy destination disk.

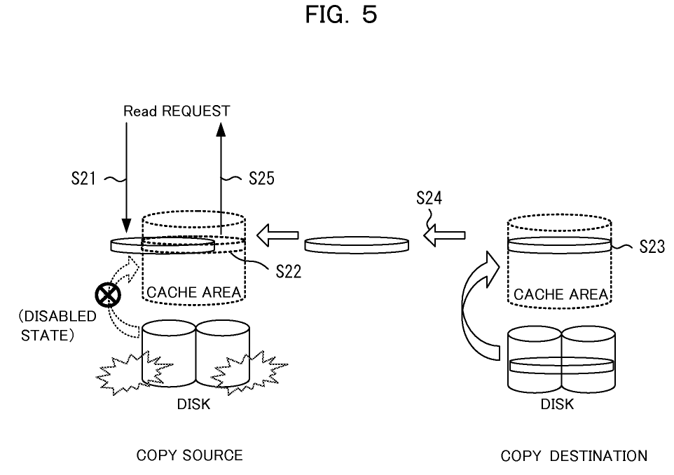

Operation of the storage system in the case where a Read request is issued from the host to copy source after occurrence of a multiple-disk failure in the copy source will be described. FIG. 5 is a conceptual view showing an example of operation performed in response to a Read request issued after occurrence of a multiple-disk failure in the copy source in the synchronous mode in the equivalent state.

(S21) The CM 11a receives the Read request which is issued from the host to the copy source.

(S22) The CM 11a allocates a cache area corresponding to the access range (unit area including the Read target) to a memory in the CM 11a. The cache area is allocated per unit area.

(S23) When recognizing that the copy source disk is in a disabled state by checking the condition of the copy source disk, the CM 11a allows the CM 11b to allocate a cache area for data read to a memory in the CM 11b, and the CM 11b reads data from the copy destination disk and develops the data in the cache area of the copy destination (staging).

(S24) The CM 11b transfers the data from the copy destination cache area to the copy source cache area.

(S25) The CM 11a returns the transferred data in the copy source cache area to the host.

Next, operation of the storage system at the time when a multiple-disk failure occurs in the copy source in the asynchronous mode in the equivalent state will be described.

As in the case of the synchronous mode, continuous operation can be achieved in this case. However, there is a difference in the reply timing to the host between the synchronous mode and asynchronous mode.

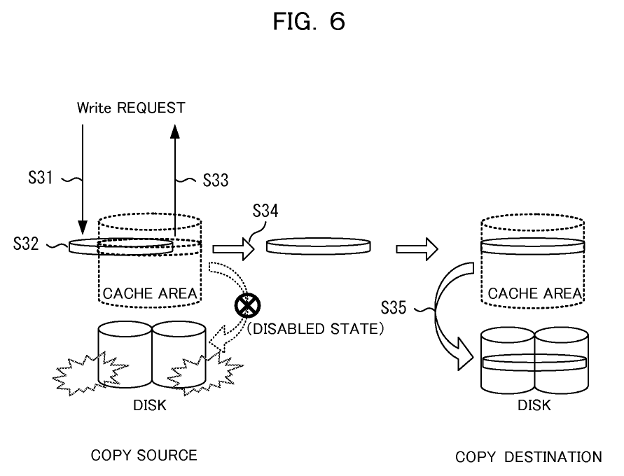

Operation of the storage system in the case where a Write request is issued from the host to the copy source after occurrence of a multiple-disk failure in the copy source will be described. FIG. 6 is a conceptual view showing an example of operation performed in response to a Write request issued after occurrence of a multiple-disk failure in the copy source in the asynchronous mode in the equivalent state.

(S31) The CM 11a receives the Write request which is issued from the host to the copy source.

(S32) The CM 11a allocates a cache area corresponding to the access range (unit area including the Write target) to a memory in the CM 11a and writes the Write request data in the cache area.

(S33) When recognizing that the current operation mode is the asynchronous mode in the equivalent state and confirming that the Write request data has been written in the copy source cache area, the CM 11a notifies, as a replay, the host of completion of the Write request.

(S34) When recognizing that the copy source disk is in a disabled state and thus data cannot be written onto the copy source disk by checking the condition of the copy source disk, the CM 11a does not perform data write operation onto the copy source disk. Further, the CM 11a allows the CM 11b to allocate a cache area for data transfer to a memory in the CM 11b and transfers the cache data of the copy source to the cache area of the copy destination.

(S35) The CM 11b writes the data written in the copy destination cache area onto the copy destination disk.

Operation of the storage system in the case where a Read request is issued from the host to copy source after occurrence of a multiple-disk failure in the copy source will be described. The operation performed in response to the Read request issued in the asynchronous mode in the equivalent state is the same as that in the synchronous mode in the equivalent state.

Next, access control per unit area performed during the data transfer from the copy source to copy destination in the case where a multiple-disk failure has occurred in the copy source in the asynchronous mode in the equivalent state will be described.

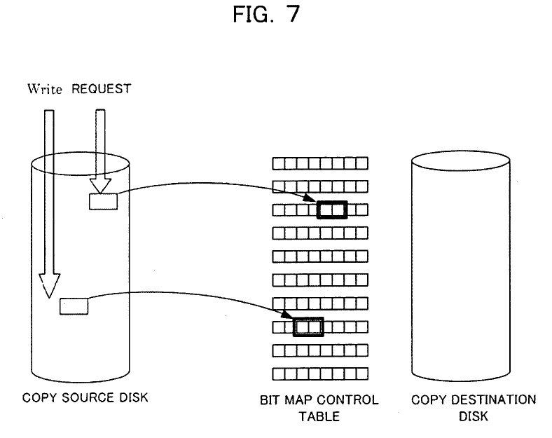

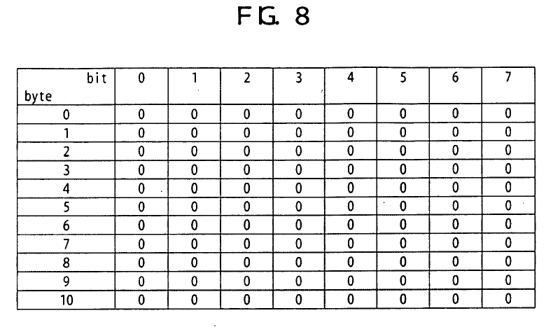

The CM 11a refers to the bit map control table to determine whether a target unit area is “data-transferred” area or “data-untransferred” area. FIG. 7 is a conceptual view showing an example of access control per unit area performed in response to a Write request issued after occurrence of a multiple-disk failure in the copy source in the asynchronous mode in the equivalent state. FIG. 8 is a table showing an example of the bit map control table in the asynchronous mode in the equivalent state. In the bit map control table of FIG. 8, bits per unit area are arranged in row direction. Each bit indicates “data-transferred (0)” or “data-untransferred (1)”. In this example, data has been retained in the cache area of the CM 11a or copy destination disk, so that it is not necessary to perform the access control per unit area by using the bit map control table. That is, all bits in the bit map control table indicate “data-transferred (0)”.

Next, operation of the storage system performed in the case where a multiple-disk failure has occurred in the copy source in the nonequivalent state will be described.

Immediately after detecting occurrence of the multiple failures in the copy source disk, the CM 11a determines whether data can be read out from an accessed unit area. When determining that data can be read from the accessed unit area, the CM 11a starts transferring the data from the copy source disk to the copy destination disk. The CM 11a uses the bit map control table to manage, for each unit area, whether data has been transferred or not from the copy source to the copy destination and, when access is made to the untransferred area of the copy source, reads data from the copy source disk and transfers it to the copy destination disk.

When determining that data in the “data-untransferred” area cannot be read from the copy source disk due to a failure in hardware such as a disk head, the data cannot be transferred to the copy destination disk, so that a recovery may fail. At this time, the CM 11a notifies the host that access to the untransferred area of the copy source is not possible.

In order for the CM 11a to determine whether data on the copy source disk can be read or not, there are available two methods: one is that the CM 11a actually accesses the data on the copy source disk to confirm whether an error has occurred or not; and the other is that the CM 11a retains disk status information to be referred to at the access time.

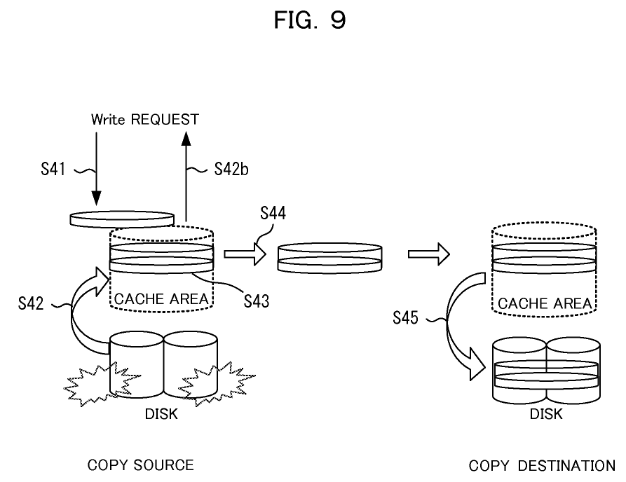

Operation of the storage system in the case where a Write request is issued from the host to copy source after occurrence of a multiple-disk failure in the copy source will be described. FIG. 9 is a conceptual view showing an example of operation performed in response to a Write request issued after occurrence of a multiple-disk failure in the copy source in the nonequivalent state.

(S41) The CM 11a receives the Write request which is issued from the host to copy source and recognizes the current operation state is the nonequivalent state.

(S42) When recognizing that the target of the Write request is included in the “data-untransferred” area, the CM 11a determines whether data can be read out from a unit area including the target of the Write request. When determining that data can be read out from a unit area including the target of the Write request, the CM 11a checks the unit area, allocates a cache area for “data-untransferred” area to a memory in the CM 11a, reads data of a size corresponding to the cache area from the copy source disk, and develops the read data in the copy source cache area.

(S42b) On the other hand, when determining that data cannot be read out from the accessed unit area of the copy source disk, the CM 11a immediately notifies the host of an error.

(S43) After developing the target data in the copy source cache area, the CM 11a writes also the Write-requested data in this cache area for data merging.

(S44) The CM 11a allows the CM 11b to allocate a copy destination cache area to a memory on the CM 11b and transfers the merged data to the copy destination cache area.

(S45) The CM 11b writes the data written in the copy destination cache area onto the copy destination disk.

With the above operation, the unit area including the target of the Write request is recognized to be the “data-transferred” area whose data has been transferred from the copy source to copy destination. Thus, when this area is accessed once again, the same operation as that in the equivalent state is performed.

Further, in the case of the asynchronous mode, the CM 11a notifies, as a reply, the host of completion of the Write request after the processing of S43. In the case of the synchronous mode, the CM 11a notifies, as a reply, the host of completion of the Write request after the processing of S44.

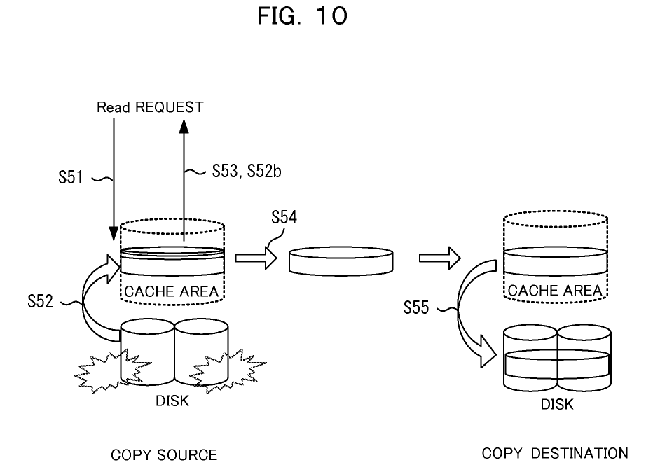

Operation of the storage system in the case where a Read request is issued from the host to copy source after occurrence of a multiple-disk failure in the copy source will be described. FIG. 10 is a conceptual view showing an example of operation performed in response to a Read request issued after occurrence of a multiple-disk failure in the copy source in the nonequivalent state.

(S51) When receiving the Read request which is issued from the host to the copy source, the CM 11a recognizes the current operation state is the nonequivalent state.

(S52) When recognizing that the target of the Read request is within the “data-untransferred” area, the CM 11a determines whether data can be read out from a unit area including the target of the Read request. When determining that data can be read out from a unit area including the target of the Read request, the CM 11a checks the unit area, allocates a cache area for “data-untransferred” area to a memory in the CM 11a, reads data of a size corresponding to the cache area from the copy source disk, and develops the read data in the copy source cache area.

(S52b) On the other hand, when determining that data cannot be read out from the accessed unit area of the copy source disk, the CM 11a immediately notifies the host of an error.

(S53) The CM 11a extracts only a range corresponding to the Read request from the cache area in which the data has been developed and notifies, as a reply, the host of the extracted range.

(S54) The CM 11a allows the CM 11b to allocate a copy destination cache area to a memory on the CM 11b and transfers the data in the copy source cache area to the copy destination cache area.

(S55) The CM 11b writes the data written in the copy destination cache area onto the copy destination disk.

With the above operation, the unit area including the target of the Read request is recognized to be the “data-transferred” area whose data has been transferred from the copy source to the copy destination. Thus, when this area is accessed once again, the same operation as that in the equivalent state is performed.

Next, access control per unit area performed during the data transfer from the copy source to the copy destination in the case where a multiple-disk failure has occurred in the copy source in the nonequivalent state will be described.

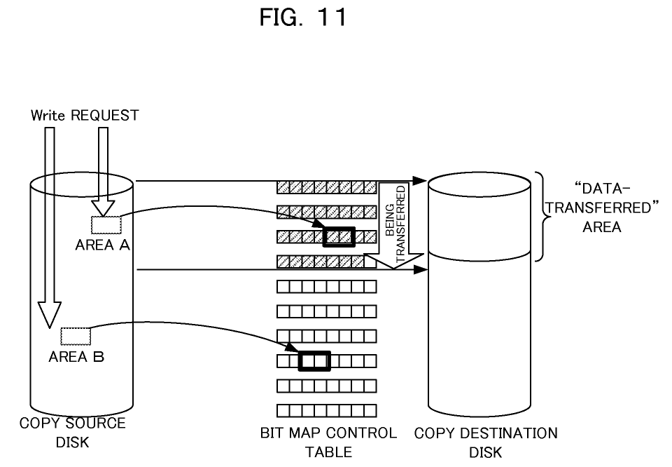

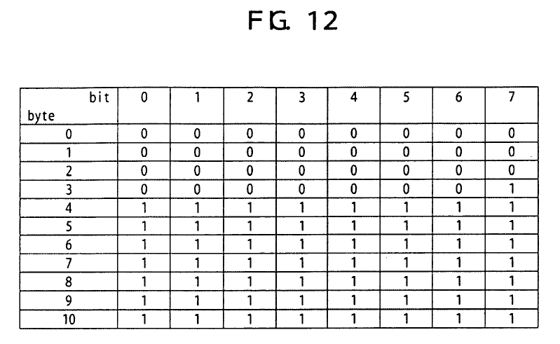

The CM 11a refers to the bit map control table to determine whether a target unit area is “data-transferred” area or “data-untransferred” area. FIG. 11 is a conceptual view showing an example of access control per unit area performed in response to a Write request issued after occurrence of a multiple-disk failure in the copy source in the nonequivalent state. When the target of a Write/Read request from the host is a unit area whose data has been transferred, the CM 11a uses data of the copy destination. FIG. 12 is a table showing an example of the bit map control table in the nonequivalent state. In the bit map control table of FIG. 12, bits per unit area are arranged in row direction. Each bit indicates “data-transferred (0)” or “data-untransferred (1)”.

The CM 11a refers to the bit of an area A, which is the target of the Write request from the host, in the bit map control table to determine that the area A is “data-transferred (0)” and perform Write operation to the area A of the copy destination. Further, the CM 11a refers to the bit of an area B, which is the target of the Write request from the host, in the bit map control table to determine that the area B is “data-untransferred (1)”, transfers data in the copy source area B to the copy destination, and perform Write operation to the area B of the copy destination.

Next, restoration operation of the copy source will be described.

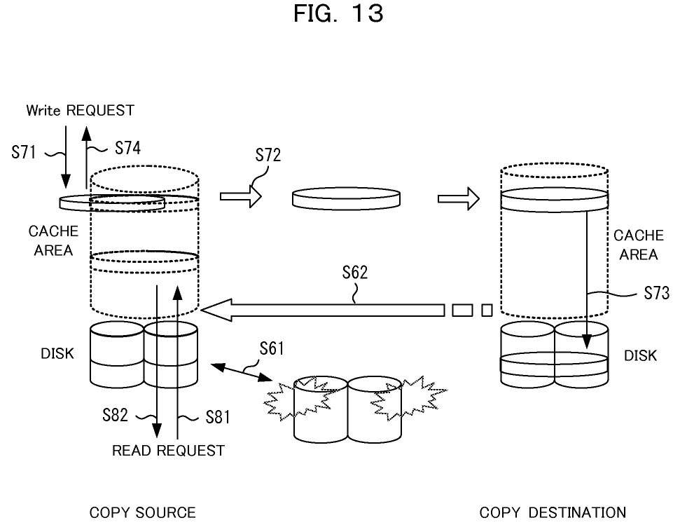

FIG. 13 is a conceptual view showing an example of operation performed in response to a Write/Read request during restoration of the copy source. When an administrator has replaced a failed disk with a new one after completion of data transfer from the copy source to the copy destination (S61), the CM 11a recognizes the replacement and starts transferring mirroring data retained in the copy destination to the copy source so as to restore the copy source (S62). After completion of the data transfer from the copy destination to the copy source, the CM 11a starts mirroring after setting back the relationship between the copy source and the copy destination to the original state, so that update of the copy source is reflected in the copy destination.

Operation performed in response to a Read/Write request issued to the copy source during restoration of the copy source will be described. The operation performed in response to a Read/Write request issued to the copy source during the data transfer from the copy source to the copy destination differs depending on whether the target of the Write request is the “data-untransferred” area or “data-transferred” area.

In the case where a Read/Write request from the host to the “data-untransferred” area has occurred, the CM 11a issues a Read/Write request to the CM 11b as a Read/Write request to an area of the corresponding copy destination.

In the case where a Write request to the “data-transferred” area has occurred (S71), the CM 11a updates the corresponding area of the copy source and transfers the updated data to the copy destination (S72). The CM 11b writes the transferred data onto the copy destination disk (S73), and the CM 11a notifies, as a replay, the host of completion of the Write request (S74).

In the case where a Read request from the host to the “data-transferred” area has occurred (S81), the CM 11a reads the data in the corresponding area of the copy source and returns the read data to the host.

Next, operation of the storage system according to the present embodiment performed in response to a Write request will be summarized.

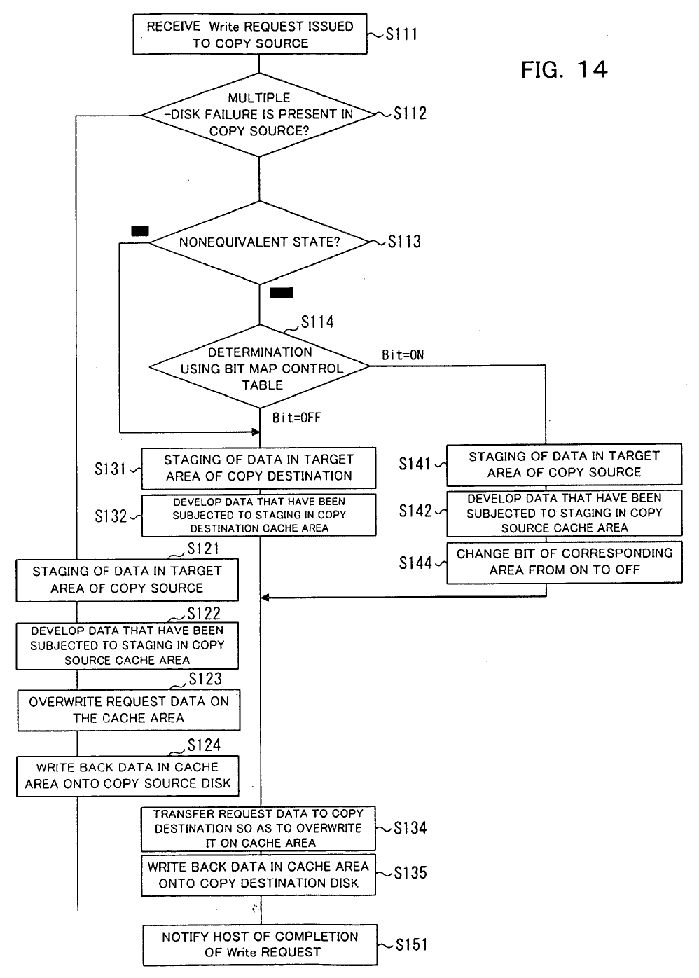

FIG. 14 is a flowchart showing an example of operation of the storage system according to the present embodiment performed in response to a Write request. When receiving a Write request which is issued from the host to the copy source (S111), the CM 11a determines whether a multiple-disk failure is present in the copy source (S112).

When determining that a multiple-disk failure is not present in the copy source (No in S112), the CM 11a performs staging of data in a corresponding area (unit area including the target of the Write request) from the copy source disk (S121), develops the data that has been subjected to the staging in the copy source cache area (S122), overwrites request data from the host on the cache area (S123), writes back the data in the cache area onto the copy source disk (S124), and advances to S151.

On the other hand, when determining that a multiple-disk failure is present in the copy source (Yes in S112), the CM 11a determines whether the current state is the nonequivalent state (S113). When determining that the current state is not the nonequivalent state (No in S113), the CM 11a advances to S131. On the other hand, when determining that the current state is the nonequivalent state (Yes in S113), the CM 11a determines whether the bit of a corresponding area in the bit map control table is ON (S114).

When determining that the bit of the corresponding area is OFF (data in the corresponding area has been transferred from the copy source to the copy destination) (No in S114), the CM 11a performs staging of corresponding data from the copy destination disk (S131), develops the data that has been subjected to the staging in the copy destination cache area (S132), transfers the request data from the host so as to overwrite it on the cache area (S134), writes back the data in the cache area onto the copy destination disk (S135), and advances to S151.

On the other hand, when determining that the bit of the corresponding area is ON (data in the corresponding area has not been transferred from the copy source to the copy destination) (Yes in S114), the CM 11a determines whether corresponding data can be read out from the copy source disk. When determining that the corresponding data can be read out from the copy source disk, the CM 11a performs staging of the corresponding data from the copy source disk (S141), transfers the data that has been subjected to the staging to the copy source cache area (S142), changes the bit of the corresponding area in the bit map control table from ON to OFF (S144), and advances to S134. Further, in the case where the corresponding data cannot be read out from the copy source disk in S141, the CM 11a immediately notifies, as a replay, the host of an error.

In S151, the CM 11a notifies, as a replay, the host of completion of the Write request, and this flow is ended.

Next, operation of the storage system according to the present embodiment performed in response to a Read request will be summarized.

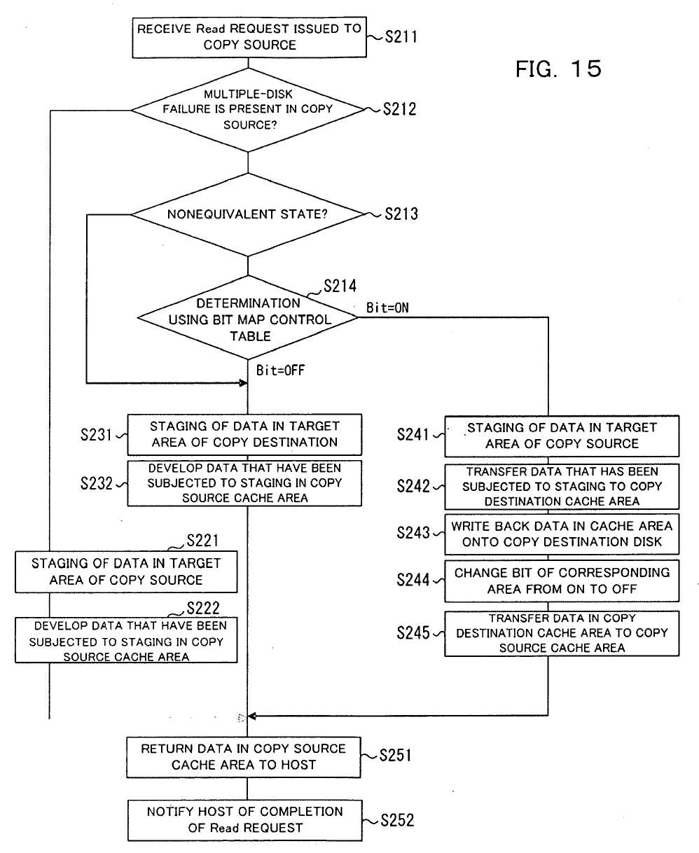

FIG. 15 is a flowchart showing an example of operation of the storage system according to the present embodiment performed in response to a Read request. When receiving a Read request which is issued from the host to the copy source (S211), the CM 11a determines whether multiple disk failures are present in the copy source (S212).

When determining that a multiple-disk failure is not present in the copy source (No in S212), the CM 11a performs staging of data in a corresponding area (unit area including the target of the Read request) from the copy source disk (S221), develops the data that has been subjected to the staging in the copy source cache area (S222), and advances to S251.

On the other hand, when determining that a multiple-disk failure is present in the copy source (Yes in S212), the CM 11a determines whether the current state is the nonequivalent state (S213). When determining that the current state is not the nonequivalent state (No in S213), the CM 11a advances to S231. On the other hand, when determining that the current state is the nonequivalent state (Yes in S213), the CM 11a determines whether the bit of a corresponding area in the bit map control table is ON (S214).

When determining that the bit of the corresponding area is OFF (data in the corresponding area has been transferred from the copy source to the copy destination) (No in S214), the CM 11a performs staging of corresponding data from the copy destination disk (S231), develops the data that has been subjected to the staging in the copy source cache area (S232), and advances to S251.

On the other hand, when determining that the bit of the corresponding area is ON (data in the corresponding area has not been transferred from the copy source to the copy destination) (Yes in S214), the CM 11a determines whether corresponding data can be read out from the copy source disk. When determining that the corresponding data can be read out from the copy source disk, the CM 11a performs staging of the corresponding data from the copy source disk (S241), transfers the data that has been subjected to the staging to the copy destination cache area (S242), writes back the data in the cache area onto the copy destination disk (S243), changes the bit of the corresponding area in the bit map control table from ON to OFF (S244), transfers the data in the copy destination cache area to the copy source cache area (S245), and advances to S251. Further, in the case where the corresponding data cannot be read out from the copy source disk in S241, the CM 11a immediately notifies, as a replay, the host of an error.

In S251, the CM 11a returns the data in the copy source cache area to the host (S251) and then notifies the host of completion of the Read request (S252), and this flow is ended.

According to the present embodiment, in the case where a multiple-disk failure has occurred in the copy source in the equivalent state, the CM 11a on the copy source side accesses the CM 11b on the copy destination side, thereby allowing access operation of the host to be continued. Further, in the case where there is any data that has not been transferred from the copy source to the copy destination in the asynchronous mode, it is possible to allow access operation to be continued by using cached data of the CM 11a.

According to the present embodiment, even in the case where a multiple-disk failure has occurred in the copy source in the nonequivalent state and where there is any data that has not been transferred from the copy source to the copy destination, if the CM 11a can access data of the copy source, it is possible to allow access operation to be continued by using the copy source data.

The above respective steps performed by the CMs 11a and 11b are executed by the CPUs 15 thereof.

A first storage unit corresponds to the disks 14a and 14b of the embodiment. A second storage unit corresponds to the disks 14c and 14d in the embodiment.

A monitoring section and a monitoring step correspond to functions of S112 and S212 of the CM 11a in the embodiment. A determination section and a determination step correspond to functions of S141 and S241 of the CM 11a in the embodiment. A selection section and selecting step correspond to functions of S121, S122, S123, S131, S132, S134, S135, S141, S142, S144, S221, S222, S231, S232, S241, S242, S243, S244, and S245 of the CM 11a in the embodiment.

The present invention can be embodied in various forms, without departing from the spirit or the main feature. Therefore, the aforementioned embodiments are merely illustrative of the invention in every aspect, and not limitative of the same. The scope of the present invention is defined by the appended claims, and is not restricted by the description herein set forth. Further, various changes and modifications to be made within the scope of the appended claims and equivalents thereof are to fall within the scope of the present invention.

What is claimed is:

1. A storage system comprising:
an interface that connects the storage system to a higher-level device;
a first storage unit that stores data which is transferred from the higher-level device through the interface;
a second storage unit onto which data stored in the first storage unit is copied;
a management table that manages the progress of the copy operation;
a monitoring section that monitors the operating state of the first storage unit;
a determination section that determines, in the case where the monitoring section detects occurrence of a failure in the first storage unit, that the access destination in the first storage unit specified by the higher-level device is accessible or not; and
a selection section that selects the access destination specified by the higher-level device based on the determination result of the determination section and progress managed by the management table.

2. The storage system according to claim 1, further comprising a storage section that temporarily stores data, wherein,
in the case where the determination section determines that the access destination in the first storage unit is inaccessible, the selection section checks whether data stored in the access destination is stored in the storage section and, if stored, accesses the storage section.

3. The storage system according to claim 1, wherein,
in the case where the access is a read request and where the monitoring section detects occurrence of a failure in the first storage unit, the determination section determines whether the read request target data can actually be read out from the first storage unit and, if can be read, the selection section reads the read request target data from the first storage unit.

4. The storage system according to claim 3, wherein
the selection section reads data including the read request target data per unit size of the copy operation as temporarily stored data and returns the target data to the higher-level device, as well as copies the temporarily stored data to the second storage unit.

5. The storage system according to claim 2, wherein,
in the case where the access is a write request and where the monitoring section detects occurrence of a failure in the first storage unit, the selection section reads, based on the management table, data including the write request target data per unit size of the copy operation from the second storage unit so as to store the data in the storage section as temporarily stored data and writes write request data on the write request target data in the temporarily stored data, as well as copies the updated temporarily stored data onto the second storage unit.

6. A controller of a storage system having a first storage unit that stores data which is transferred from a higher-level device through an interface connected to the higher-level device and a second storage unit onto which data stored in the first storage unit is copied, comprising:
a management table that manages the progress of the copy operation;
a monitoring section that monitors the operating state of the first storage unit;
a determination section that determines, in the case where the monitoring section detects occurrence of a failure in the first storage unit, that the access destination in the first storage unit specified by the higher-level device is accessible or not; and
a selection section that selects the access destination specified by the higher-level device based on the determination result of the determination section and progress managed by the management table.

7. The controller according to claim 6, further comprising a storage section that temporarily stores data, wherein,
in the case where the determination section determines that the access destination in the first storage unit is inaccessible, the selection section checks whether data stored in the access destination is stored in the storage section and, if stored, accesses the storage section.

8. The controller according to claim 6, wherein,
in the case where the access is a read request and where the monitoring section detects occurrence of a failure in the first storage unit, the determination section determines whether the read request target data can actually be read out from the first storage unit and, if can be read, the selection section reads the read request target data from the first storage unit.

9. The controller according to claim 8, wherein
the selection section reads data including the read request target data per unit size of the copy operation as temporarily stored data and returns the target data to the higher-level device, as well as copies the temporarily stored data to the second storage unit.

10. The controller according to claim 7, wherein,
in the case where the access is a write request and where the monitoring section detects occurrence of a failure in the first storage unit, the selection section reads, based on the management table, data including the write request target data per unit size of the copy operation from the second storage unit so as to store the data in the storage section as temporarily stored data and writes write request data on the write request target data in the temporarily stored data, as well as copies the updated temporarily stored data onto the second storage unit.

11. A control method of a storage system having a first storage unit that stores data which is transferred from a higher-level device through an interface connected to the higher-level device and a second storage unit onto which data stored in the first storage unit is copied, comprising:
a management step that manages the progress of the copy operation;
a monitoring step that monitors the operating state of the first storage unit;
a determination step that determines, in the case where the monitoring step detects occurrence of a failure in the first storage unit, that the access destination in the first storage unit specified by the higher-level device is accessible or not; and
a selection step that selects the access destination specified by the higher-level device based on the determination result of the determination step and progress managed by the management table.

12. The control method according to claim 11, further comprising a storage step that temporarily stores data, wherein,
in the case where the determination step determines that the access destination in the first storage unit is inaccessible, the selection step checks whether data stored in the access destination is stored in the storage section and, if stored, accesses the storage section.

13. The control method according to claim 11, wherein,
in the case where the access is a read request and where the monitoring step detects occurrence of a failure in the first storage unit, the determination step determines whether the read request target data can actually be read out from the first storage unit and, if can be read, the selection step reads the read request target data from the first storage unit.

14. The control method according to claim 13, wherein
the selection step reads data including the read request target data per unit size of the copy operation as temporarily stored data and returns the target data to the higher-level device, as well as copies the temporarily stored data to the second storage unit.

15. The control method according to claim 12, wherein,
in the case where the access is a write request and where the monitoring step detects occurrence of a failure in the first storage unit, the selection step reads, based on the management table, data including the write request target data per unit size of the copy operation from the second storage unit so as to store the data in the storage section as temporarily stored data and writes write request data on the write request target data in the temporarily stored data, as well as copies the updated temporarily stored data onto the second storage unit.
